(19) United States
(12) Patent Application Publication
(10) Pub. No.: US 2009/0002389 A1
(43) Pub. Date: Jan. 1, 2009

(54) IMAGE DISPLAY APPARATUS AND MANUFACTURING METHOD THEREOF

(75) Inventors: Hirotomo Taniguchi, Kawasaki-shi (JP); Jun Iba, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/143,954

(22) Filed: Jun. 23, 2008

(30) Foreign Application Priority Data
Jun. 27, 2007 (JP) 2007-168486

(51) Int. Cl. G06F 3/038; G09G 3/00

(52) U.S. Cl. 345/589; 345/214

(57) ABSTRACT

An image display apparatus has a plurality of display devices and a correction circuit which corrects image data in order to reduce luminance unevenness among the plurality of display devices. The correction circuit has a first storing unit which stores first characteristic data of each of the display devices which represent variation characteristics of luminance with respect to drive time therein, a second storing unit which stores drive time data which represent values correlated with drive time of the display devices and are updated when the display devices are driven, and a calculation unit which calculates correction values corresponding to each of the display devices based on the first characteristic data and the drive time data.

### BACKGROUND OF THE INVENTION

1. Field of the Invention

The present invention relates to an image display apparatus having a plurality of display devices and a manufacturing method thereof.

2. Description of the Related Art

In image display apparatuses which form images using a plurality of display devices, variation in luminance of the display devices causes a deterioration in image quality.

Japanese Patent Application Laid-Open No. 2004-325565 (FIG. 2) discloses a method for obtaining a deterioration quantity of luminance based on previously measured luminance deterioration characteristics of RGB and accumulated lighting time of the display devices so as to correct luminance balance of RGB in EL displays.

### SUMMARY OF THE INVENTION

The characteristics of time variation in luminance of the display devices, however, vary according to not only colors but also devices. For this reason, when the characteristics of variation with time varies in the plurality of display devices composing the image display apparatus, even if the correction in JP-A No. 2004-325565 is applied, luminance unevenness among the display devices cannot be sufficiently corrected.

The present invention solves the above problem, and its object is to provide an image display apparatus which can reduce the luminance unevenness caused by the time variation in luminance and can display images with high quality for a long period, and a manufacturing method thereof.

According to a first aspect of the present invention, there is provided an image display apparatus, including:

a plurality of display devices; and

a correction circuit which corrects image data in order to reduce luminance unevenness among the plurality of display devices,

wherein the correction circuit includes:

a first storing unit which stores first characteristic data of each of the display devices which represent variation characteristics of luminance with respect to drive time;

a second storing unit which stores drive time data which represent values correlated with the drive time of the display devices and are updated when the display devices are driven; and

a calculation unit which calculates correction values corresponding to each of the display devices based on the first characteristic data and the drive time data.

According to a second aspect of the present invention, there is provided a method for manufacturing an image display apparatus having a plurality of display devices, including the steps of:

measuring luminance or physical quantities correlated with the luminance of the display devices at the time of driving the display devices for a predetermined measuring period;

calculating first characteristic data of each of the display devices which represent variation characteristics of luminance with respect to drive time based on measured values obtained at the measuring step; and

storing the calculated first characteristic data in a storing unit of the image display apparatus.

According to the present invention, the image display apparatus, which reduces the luminance unevenness due to the time variation in the luminance and can display images with high quality for a long period, can be provided.

### BRIEF DESCRIPTION OF THE DRAWINGS

FIG. 1 is a block diagram illustrating a basic constitution of an image display apparatus according to a first embodiment;

FIG. 2 is a graph illustrating variation in luminance with time and its fitting curve;

FIG. 3 is a diagram illustrating a data structure of a first storing unit;

FIGS. 4A and 4B are diagrams illustrating a data structure of a second storing unit;

FIGS. 5A to 5C are diagrams illustrating correction examples according to the first embodiment;

FIGS. 6A to 6C are diagrams illustrating a modulating method;

FIG. 7 is a block diagram illustrating a constitution of the image display apparatus according to the first embodiment;

FIG. 8 is a block diagram illustrating a basic constitution of the image display apparatus according to a second embodiment;

FIG. 9 is a graph illustrating variation in device currents with time and its fitting curve;

FIG. 10 is a graph illustrating one example of phosphor deterioration characteristics;

FIG. 11 is a diagram illustrating a data structure of a third storing unit;

FIG. 12 is a block diagram illustrating a constitution of the image display apparatus according to the second embodiment;

FIGS. 13A and 13B are diagrams illustrating a constitution of a surface-conduction emission device;

FIG. 14 is a diagram illustrating a constitution of a display panel;

FIG. 15 is a graph illustrating a fluctuation in the luminance in an Example 1;

FIGS. 16A to 16E are diagrams illustrating correction examples in the Example 1;

FIG. 17 is a graph illustrating a corrected effect in the Example 1;

FIGS. 18A to 18E are diagrams illustrating correction examples in a comparative example;

FIG. 19 is a graph illustrating a corrected effect in an Example 2;

FIG. 20 is a graph illustrating a fluctuation in a device current in an Example 3;

FIG. 21 is a graph illustrating a corrected effect in the Example 3 and;

FIG. 22 is a graph illustrating a corrected effect in an Example 4.

### DESCRIPTION OF THE PREFERRED EMBODIMENTS

Preferred embodiments of the present invention are described in detail below with reference to the drawings.

The present invention is preferably applied to a self-luminous image display apparatus. Examples of this kind of image display apparatuses include image display apparatuses using electron-emitting devices (cold cathode electron-emitting devices), EL displays, LED displays and PDPs. The present invention is preferably applied to the image display apparatus using the electron-emitting devices in all of them because variation in emission current-voltage characteristics with time varies among the electron-emitting devices.

In the image display apparatus using electron-emitting devices, an electron-emitting device and phosphor (illuminant) opposed to the electron-emitting device compose a display device. Examples of the electron-emitting devices include field-emission devices (FE devices), surface-conduction emission devices (SCE devices), and metal/insulation/metal devices (MIM devices).

### First Embodiment

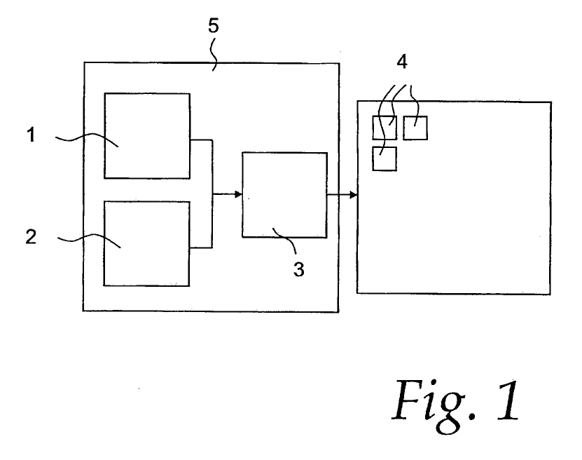

A first embodiment is described with reference to the block diagram of FIG. 1. FIG. 1 is a block diagram illustrating the image display apparatus according to the first embodiment of the present invention.

### (Basic Constitution)

As shown in FIG. 1, the image display apparatus has a plurality of display devices 4, and a correction circuit which corrects image data so as to reduce luminance unevenness among the plurality of display devices 4. The correction circuit 5 has a first storing unit 1, a second storing unit 2, and a correction value calculation unit 3. Nonvolatile semiconductor memories can be suitably adopted as the first storing unit 1 and the second storing unit 2, but they can be composed of magnetic storage media.

### (First Storing Unit)

The first storing unit 1 stores luminance variation characteristic data (first characteristic data) showing luminance variation characteristic with respect to drive time (hereinafter, simply “luminance variation characteristic”) therein. Since the luminance variation characteristic can be specific to the respective display devices, the first storing unit 1 stores luminance variation characteristic data about each of the plurality of display devices 4 respectively therein. The luminance variation characteristic data are stored in the first storing unit 1 at a step of manufacturing the image display apparatus.

The “variation in luminance with respect to the drive time” includes a case where as the drive time of the display devices becomes longer, the luminance becomes lower (deteriorated), and a case where as the drive time becomes longer, the luminance becomes higher (improved). Hereinafter, the “variation in luminance with respect to the drive time” is also simply described as “variation in luminance with time”.

The luminance variation characteristic data does not have to represent variation in a luminance value of the display devices, and may represent variation in value of “physical quantity correlated with the luminance”. In the case of a cold cathode electron-emitting device, the physical quantity correlated with the luminance includes an electric current (drive current) which is applied between a cathode electrode and a gate electrode of the electron-emitting device, an electric current (emission current) which is applied from an electron-emitting device to an anode electrode, and an electron emission efficiency.

The luminance variation characteristic data is calculated based on the luminance of the respective display devices or measured values of the physical quantity correlated with the luminance, or is calculated based on a database of the luminance of the display devices or the physical quantity correlated with the luminance. Precisely, since the luminance variation characteristic varies in each display device, actual measured values are preferably used in order to improve correction accuracy. That is to say, the individual display devices of the image display apparatus are actually driven, the luminance or the physical quantity correlated with the luminance is measured, and the data about the luminance variation characteristics of the individual display devices is calculated based on the obtained measured values. The luminance may be measured directly by using a luminance meter, or the driving current or the emission current may be measured by using an electrical measuring system. The measuring device for measuring the luminance or the physical quantity correlated with the luminance can be installed into the image display apparatus. If the image display apparatus has the measuring device, the data about the luminance variation characteristic can be suitably updated.

The format of the luminance variation characteristic data may be coefficients (parameters) representing an approximate curve of the luminance variation characteristics, or a look-up table. From a viewpoint of reducing a storage region, it is preferable that the luminance variation characteristic data is retained in the former coefficient format. The approximate curve of the luminance variation characteristics can be expressed by a function of time composed of one or a plurality of coefficients. For example, the approximation curve is expressed by a logarithmic approximation formula in Formula 1:

Li=ai×Log(Ti)+bi (Formula 1)

In the Formula 1, Li denotes prediction luminance, and Ti denotes accumulated drive time. Coefficients ai and bi denote the luminance variation characteristic data, and they are parameters which do not depend on the time. i denotes a number of a display device.

At an initial driving stage, the characteristics of the display devices may greatly fluctuate due to an influence of emitted gas or the like. For this reason, preliminary drive time referred to as aging is occasionally set at the initial stage. When such aging period is set, offset time T0 corresponding to the aging period may be introduced like a Formula 2.

Li=ai×Log(Ti−T0)+bi (Formula 2)

The formula which expresses the luminance variation characteristic varies according to a type of the devices, a manufacturing method of the devices and a driving condition. For example, the characteristic is expressed by a linear formula like a Formula 3. Any formulas may be adopted as long as the formulas are expressed by the function of time having one or a plurality of coefficients.

Li=ai+bi×Ti (Formula 3)

### (Second Staring Unit)

The second storing unit 2 stores drive time data which represent values correlated to the drive time of the display devices therein. The value of the drive time data is zero at an initial stage, and when the display devices are driven, the drive time data are updated.

“The value correlated with the drive time” (hereinafter, simply “drive time correlated value”) is an accumulated total of the drive time of the display devices, or an accumulated total of values obtained by adjusting the drive time of the display devices according to gradation values. The latter value can be called also as an accumulated total of values obtained by weighing the drive time of the display devices according to the gradation values.

When a driving signal is a simple pulse width modulated signal, the former value (namely, the total value of the pulse widths of the driving signal) is preferable. When the driving signal is an amplitude modulated signal or a combined signal of the pulse width modulation and the amplitude modulation, the latter value is preferable. For example, in the case of the amplitude modulated signal, the pulse width is constant regardless of the gradation value, and the luminance of the devices varies according to the level of the amplitude. Therefore, in the case of the driving for one hour with maximum gradation (maximum amplitude), “1 hour” is added to the drive time data, but in the case of the driving for 1 hour with 50% of the maximum gradation, only “0.5 hour” is added. That is to say, not the time of actually applying signals is accumulated but corresponding values at the time when signals with maximum gradation (maximum amplitude) are supposed to be applied is accumulated. In other words, values corresponding to time integration of the amplitudes of the driving signals are accumulated. The same holds for the case of a signal where the pulse width modulation and the amplitude modulation are combined (a signal which obtains a plurality of amplitude values in one driving signal waveform).

The drive time data are preferably updated and stored individually for all the display devices 4. This is because the correcting accuracy is improved.

From a viewpoint of reducing the storage region, the common drive time data may be used for two or more display devices. The value represented by this data is a central value of the drive time correlated values of two or more display devices. Examples of such a central value include an average value of the drive time correlated values of all the display devices and the drive time corrected values of the plurality of display devices Further, the drive time correlated value of a certain display device, such as a display device at the center of an image area, may be used as the central value. Further, a general average value according to an output object may be used. In the case of a TV video, since average luminance is 20% to 30% of the maximum luminance, 20% to 30% of the actual drive time may be used as a central value of the drive time correlated value.

### (Correction Value Calculation Unit)

The correction value calculation unit 3 refers to the first storing unit 1 and the second storing unit 2 so as to obtain a variation amount in the luminance of the respective display devices with time (decrease amount or increase amount) based on the luminance variation characteristic data specific to the display devices and the drive time data. The correction value calculation unit 3 determines a correction target value based on the variation amount in the luminance of all the display devices with time. The correction value calculation unit 3 obtains a correction value for correcting an input signal (input image data) so that the display devices have luminance of the correction target values.

### (Correcting Method)

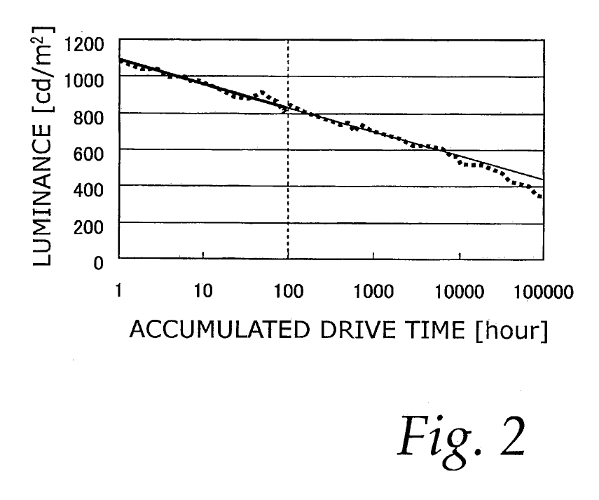

A concrete correcting method is described with reference to FIG. 2. FIG. 2 illustrates one example of a luminance fluctuation of a certain display device.

The luminance fluctuation (broken line) shown in FIG. 2 has a fluctuation component corresponding to the variation in the luminance with time and a fluctuation component of a comparatively mid-to-high frequency which is called as fluctuation. An ordinate axis in FIG. 2 shows the luminance at the time of driving with maximum gradation, and an abscissa axis shows the drive time. That is to say, FIG. 2 illustrates the variation characteristics of the luminance with respect to the drive time when a certain display device is continued to be driven with maximum gradation.

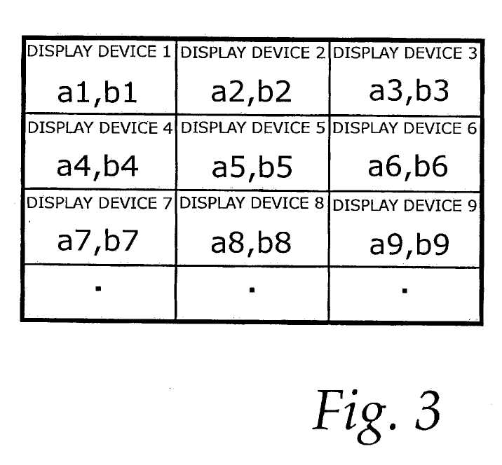

The logarithmic approximation formula of the Formula 1 is fitted to the luminance fluctuation shown in FIG. 2, so that coefficients ai and bi representing the luminance variation characteristics can be obtained. The coefficients ai and bi of all the display devices are obtained, and as shown in FIG. 3, they are stored as the luminance variation characteristic data in the first storing unit 1. FIG. 3 schematically illustrates a data structure of the first storing unit 1.

When a unit of the time Ti in the Formula 1 is set to hour, and a unit of the prediction luminance Li is set to cd/m², the coefficient ai roughly takes a value of −250 to 250, and the coefficient bi roughly takes a value of 250 to 2000. When the coefficient ai takes a positive value, as the drive time Ti becomes longer, the prediction luminance Li becomes longer (improved).

In the first embodiment, the coefficients ai and bi which are the luminance variation characteristic data are obtained by fitting the logarithmic approximation formula of the Formula 1 to the luminance fluctuation for the initial drive time of 0 to 100 hours. As shown in FIG. 2, a fitting curve (solid line) which is obtained by the luminance fluctuation for 100 hours at the initial driving stage is well fitted to the luminance fluctuation after 100 hours.

In the example of FIG. 2, an error between the luminance fluctuation and the fitting curve becomes gradually larger around 10000 hours and after. This is because the luminance is deteriorated due to a factor which is not taken into consideration at the time of obtaining the coefficients ai and bi. Concretely, it is considered that this is caused by an influence of a deterioration in the phosphors with time which is not taken into consideration in the first embodiment.

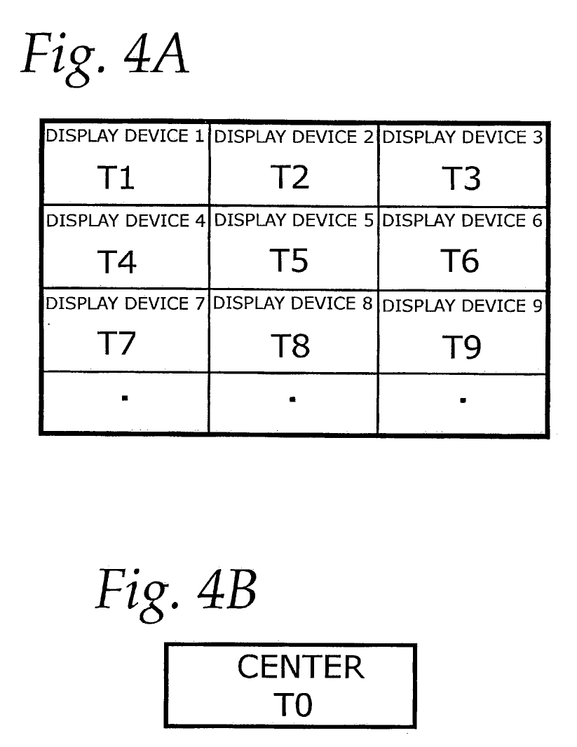

FIGS. 4A and 4B schematically illustrate data structures of the second storing unit 2. In FIG. 4A, drive time data Ti of the display devices are stored individually. When the individual drive time data are used, the variation amount in the luminance of the display devices with time can be obtained accurately. On the other hand, in FIG. 4B, only the drive time data T0 representing a central value is stored. The correction value calculation unit 3 calculates the correction values of all the display devices commonly using the drive time data T0 as the central value (the luminance variation characteristic data specific to each display device is used).

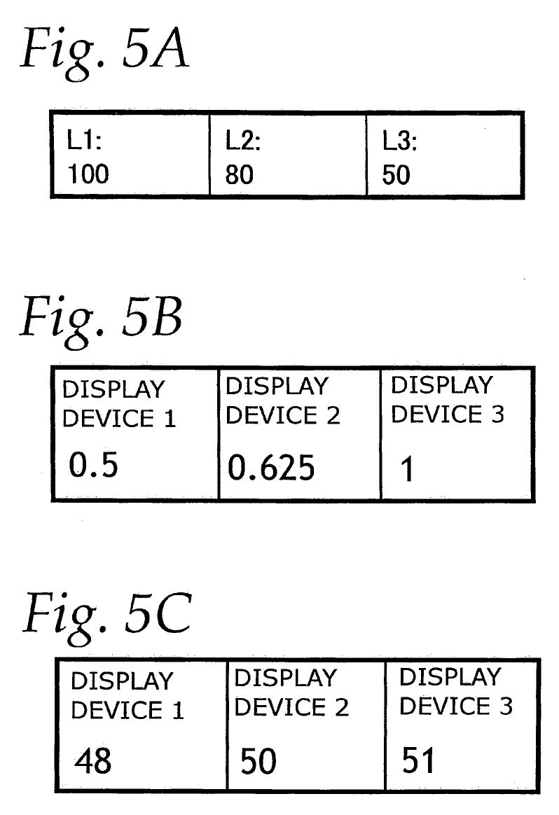

A correcting example at certain drive time t1 is described below with reference to FIGS. 5A to 5C. FIG. 5A illustrates the prediction luminance L1 to L3 of the display devices 1 to 3, FIG. 5B illustrates the correction value, and FIG. 5C illustrates measured luminance after the correction.

The correction value calculation unit 3 reads the coefficients ai and bi from the first storing unit 1, and reads the drive time Ti (=t1) from the second storing unit 2. The prediction luminance L1 to L3 of the display devices 1 to 3 at the drive time t1 is calculated according to the Formula 1. The correction target values are determined based on the calculated prediction luminance L1 to L3 of all the display devices. The correction values to be applied to the display devices 1 to 3 are obtained from the correction target values. In the example of FIGS. 5A to 5C, the correction target value is determined as 50 based on the prediction luminance L1: 100, L2: 80 and L3: 50 of the display devices 1 to 3, and the correction values of all the devices are calculated so that the luminance of all the display devices becomes 50.

When such a correction is made, luminance unevenness among the display devices which is caused by a difference in the luminance variation characteristics can be reduced. The luminance unevenness can be evaluated by a value “σ (standard deviation) of the luminance/average value” in the case where signals with uniform gradation are input into all the display devices.

As the correction target value is set to be smaller, the luminance unevenness is reduced. As shown in FIG. 5A to 5C, the minimum value of the prediction luminance is selected as the correction target value, so that the reducing effect of the luminance unevenness becomes maximum. However, when the correction target value is set to be too small, the entire display luminance is reduced, and this is not preferable. Therefore, the correction target value is suitably set according to specifications of devices.

The luminance of all the display devices does not necessarily have to be uniform. The luminance unevenness may be not more than an acceptability limit of audiences of the image display apparatus. Concretely, when “σ of the luminance/average value” is about 1% to 3%, the luminance unevenness is not noticeable. Therefore, the correction target value may be set to a value of luminance unevenness which is not more than the acceptability limit of audience of the image display apparatus.

When the correction target value is set to a value larger than the minimum value of the prediction luminance of all the devices, image data after the correction possibly exceeds the maximum gradation. Therefore, a limiter is preferably provided and limits the value of the image data after the correction so that the value does not exceed the maximum gradation. In another manner, a gain is applied to the image data, so that the value of the image data after the correction may be adjusted so as not to exceed the maximum gradation. In yet another manner, it is preferable that a length of one horizontal scanning period of each scanning line is suitably changed according to a value range of the image data after the correction.

The image data are corrected by using the correction values obtained in the above correcting method, and display devices 4 are driven by the corrected image data. As a result, the luminance unevenness of the image display apparatus is reduced.

### (Measuring Period of Luminance Variation Characteristics)

In the first embodiment, the luminance variation characteristic data is calculated by using the Formulas 1 to 3 based on measured results of the luminance for 100 hours at the initial driving stage (or physical quantity correlated with the luminance). That is to say, long-period luminance variation characteristics specific to the display devices can be estimated only by measuring the initial variation in the luminance with time, and the parameters to be stored in the first storing unit 1 can be determined.

In the first embodiment, 100 hour from the start of driving is set to predetermined measuring time, but the measuring period is not limited to this. This is because the tendency in the luminance variation with time varies according to types, shapes and materials of the display devices. For example, the variation characteristics of the current-voltage characteristics of an electron-emitting device with respect to time vary among FE devices, SCE devices and MIM devices, and vary even in the FE devices according to their shapes and materials. Therefore, it is desirable to suitably determine the measuring period according to the characteristics of display devices to be used so that the luminance variation characteristic data obtained from the luminance fluctuation at the measuring period will well predict the luminance fluctuation after the measuring period.

### (Modulating Method)

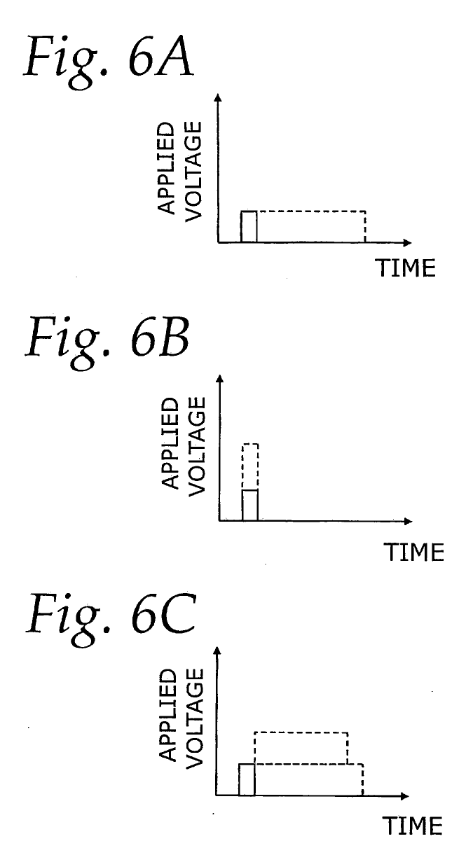

Modulation of a driving signal (modulation signal) to be given to the display devices is described with reference to FIGS. 6A to 6C. The corrected image data (or data after the corrected image data is subject to a certain process) is input into a modulation circuit which generates a driving signal.

The modulating method includes a pulse width modulating system shown in FIG. 6A, a pulse amplitude modulating system shown in FIG. 6B, and a system shown in FIG. 6C where the pulse width modulation and the pulse amplitude modulation are combined. Any modulating system may be applied to the image display apparatus in the first embodiment. In the pulse width modulating system, gradation is expressed by changing a pulse width of a voltage to be applied to the display devices for one horizontal scanning period. Further, in the pulse amplitude modulating system, the gradation is expressed by changing a voltage amplitude of a pulse to be applied.

### (Block Diagram)

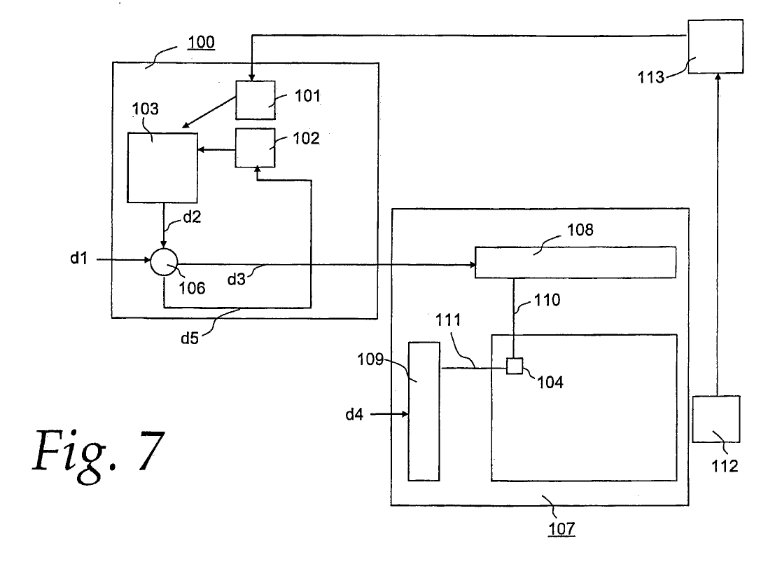

FIG. 7 is a block diagram illustrating details of the image display apparatus in FIG. 1. The image display apparatus has a display panel 107 and a correction circuit 100. The display panel 107 has a plurality of display devices 104, a modulating circuit 108, a scanning circuit 109, column-direction wirings 110, and row-direction wirings 111. The correction circuit 100 has a first storing unit 101, a second storing unit 102, a correction value calculation unit 103, and a multiplier 106. A reference numeral 112 denotes an unevenness measuring unit, and a reference numeral 113 denotes an operating unit which calculates the luminance variation characteristic data to be stored in the first storing unit 101. The unevenness measuring unit 112 and the operating unit 113 may be components of the image display apparatus, or may be independent from the image display apparatus.

### (Flow of Signal)

Reference numerals d1 to d5 in FIG. 7 denote signal information. In FIG. 7, the signal information is drawn by one line, but actually the signal information is line data for the number of the display devices.

In order to obtain the luminance variation characteristic data from the measured value, the image data d1 for measurement is firstly input. In order to display images suitable for measurement, the correction data d2, if necessary, is transmitted from the correction value calculation unit 103 to the multiplier 106. The multiplier 106 operates the data d1 and d2 so as to convert them into corrected image data d3 for displaying images suitable for the measurement. The data d3 is transmitted to the modulating circuit 108. When the multiplier 106 does not perform an operation on the data d1 and d2, the image data d1 is transmitted as the corrected image data d3 to the modulating circuit 108.

A synchronous signal d4 of the image data d1 is transmitted to the scanning circuit 109. The modulating circuit 108 and the scanning circuit 109 transmit signals to the display devices 104 via the column-direction wiring 110 and the row-direction wiring 111, so that the display devices 104 are driven. At this time, the display devices 104 may be driven one by one, or they may be driven simultaneously. As a result, an image for measuring luminance unevenness is displayed. The unevenness measuring unit 112 measures the luminance of the display devices 104 (or the physical quantity such as device currents correlated with the luminance). Data measured by the unevenness measuring unit 112 is transmitted to the operating unit 113. The operating unit 113 calculates luminance variation characteristic data (coefficients ai and bi) of each display device 104 based on the measured data.

When the luminance variation characteristic data is calculated from the database (not shown), the operating unit 113 calculates the coefficients ai and bi from the data read from the database, and allows the values to be stored in the first storing unit 101.

The correction for reducing the luminance unevenness is carried out in the following manner. The correction value calculation unit 103 calculates correction values corresponding to the display devices 104 based on the luminance variation characteristic data in the first storing unit 101 and the drive time data in the second storing unit 102. The calculated correction values are sent as the correction data d2 to the multiplier 106. The multiplier 106 generates the corrected image data d3 based on the image data d1 input into the correction circuit 100 and the corrected data d2. The modulating circuit 108 generates a driving signal (modulating signal) from the corrected image data d3 so as to output the driving signal to the column-direction wiring 110. As a result, the image whose luminance unevenness is reduced is displayed.

The drive time data stored in the second storing unit 102 is updated according to driving of the display devices. In the constitution of FIG. 7, the same data d5 as the corrected image data d3 is transmitted as information representing the length of the drive time of the display devices to the second storing unit 102. The second storing unit 102 calculates drive time correlation values based on the data d5 so as to update the drive time data of the corresponding devices.

### (Driving Method)

The driving of the image display apparatus is carried out by a simple matrix system or an active matrix system. The simple matrix system is describe below with reference to FIG. 7. The display devices 104 are connected to intersection points between the column-direction wirings 110 and the row-direction wirings 111 which are arranged into a matrix pattern, respectively. The column-direction wirings 110 are connected to the modulating circuit 108, and the row-direction wirings 111 are connected to the scanning circuit 109.

A certain row of the display panel 107 is selected for one horizontal scanning period of an image. A scanning signal is applied from the scanning circuit 109 to the row-direction wiring 111 on the selected row. As a result, the scanning signal is applied to the display device connected to the selected row.

On the other hand, the modulating circuit 108 simultaneously outputs information signals (modulating signals) for each of the display devices on the selected row for selected one horizontal scanning period. The information signals are supplied to the display devices via the column-direction wirings 110.

The display devices emit light only when the scanning signals and the information signals are applied simultaneously. As a result, the display devices on the selected rows emit light with desired luminance according to a pulse width or an amplitude of the information signals. The selected rows are sequentially switched during one vertical scanning period, so that an image can be displayed.

According to the above constitution, the luminance unevenness due to the variation in the luminance with time is reduced, so that images with high quality can be displayed for a long period. Further, since the luminance variation characteristic data specific to the devices are used so that the correction is carried out, even if devices with different characteristics are mixed, sufficient luminance unevenness reducing effect can be obtained.

### Second Embodiment

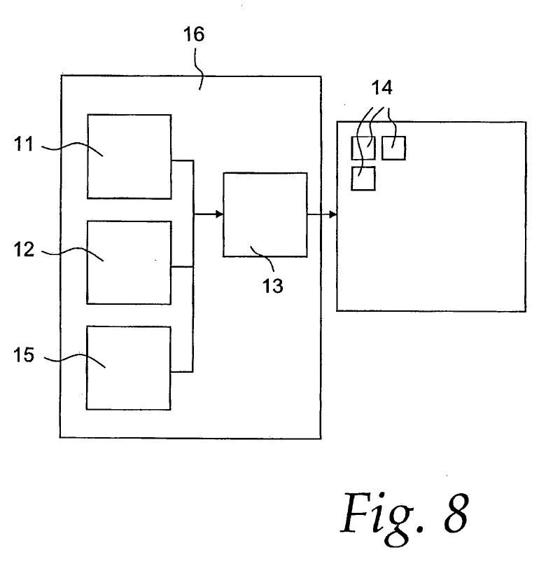

A second embodiment is described with reference to the block diagram of FIG. 8. FIG. 8 is a block diagram illustrating the image display apparatus according to the second embodiment of the present invention.

As shown in FIG. 8, the image display apparatus has the plurality of display devices 14, and the correction circuit 16 which corrects image data in order to reduce luminance unevenness among the plurality of display devices 14. The correction circuit 16 has the first storing unit 11, the second storing unit 12, a third storing unit 15, and the correction value calculation unit 13. The display devices 14 in the second embodiment are composed of electron-emitting devices and phosphors. The first to third storing units are composed of nonvolatile memories.

### (First Storing Unit)

The first storing unit 11 stores luminance variation characteristic data of the display devices 14 therein. In the second embodiment, not the variation in the luminance with time but the variation in device currents with time as the physical quantity correlated with the luminance is used as the luminance variation characteristic data. An emission current which is emitted from electron-emitting devices is defined as the device current here, but another electric current (for example, a driving current) correlated with the emission current may be defined as the device current.

### (Second Storing Unit)

A constitution of the second storing unit 12 is similar to that in the first embodiment (the second storing unit 2 in FIG. 1).

### (Third Storing Unit)

The third storing unit 15 stores phosphor deterioration characteristic data (second characteristic data) representing deterioration characteristics of the phosphors with respect to drive time (hereinafter, simply “phosphor deterioration characteristic”) therein. The phosphor deterioration characteristics are expressed by Formula 4.

$$\frac{A}{{A}_{0}} = \frac{1}{1 + Q / {Q}_{50 \%}} \qquad ( Formula 4 )$$

A denotes luminance efficiency of the phosphors, A0 denotes initial luminance efficiency of the phosphors, A/A0 denotes deterioration rate of the phosphors, Q[C/cm²] denotes a total electric charge injection amount, and Q_{50%} [C/cm²] denotes a total electric charge injection amount where the luminance efficiency of the phosphors is deteriorated to 50%. The third storing unit 15 stores a value of Q_{50%} which is measured in advance therein.

### (Correction Value Calculation Unit)

The correction value calculation unit 13 refers to the first storing unit 11 and the second storing unit 12 so as to obtain the variation amount in the device currents of the display devices with time (decrease amount or increase amount) based on the luminance variation characteristic data specific to the respective display devices and the drive time data. The correction value calculation unit 13 refers to the third storing unit 15 and the second storing unit 12 so as to obtain deterioration rate of each of the phosphors of the display devices based on the phosphor deterioration characteristic data and the drive time data. The correction value calculation unit 13 calculates the variation amount in the luminance of the display devices with time based on the variation amount in the device currents with time and the deterioration rate of the phosphors. The correction value calculation unit 13, then determines a correction target value based on the variation amount in the luminance of the entire display devices with time. The correction value calculation unit 13 obtains correction valued for correcting input signals (input image data) so that the display devices have luminance of the correction target values.

### (Correcting Method)

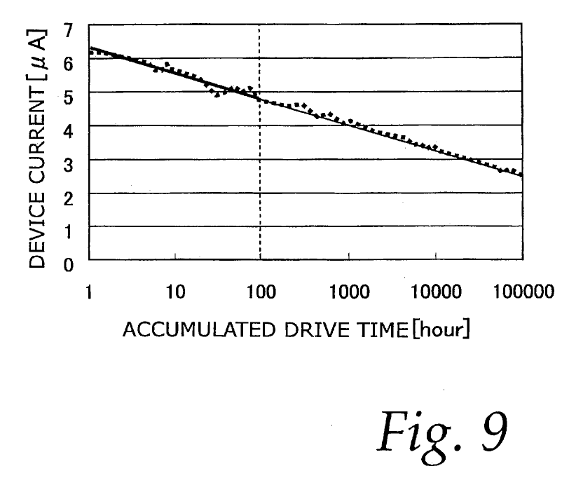

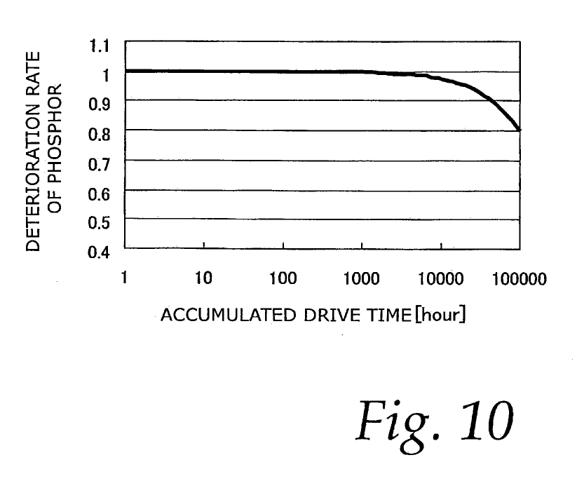

A correcting method in the second embodiment is described with reference to FIGS. 9 and 10. FIG. 9 illustrates the variation in the device currents of a certain electron-emitting device with time. An ordinate axis in FIG. 9 shows an emission current at the time of driving with maximum gradation, and an abscissa axis shows the drive time. That is to say, FIG. 9 illustrates the variation characteristics of the emission current with respect to the drive time when a certain electron-emitting device is continuously driven with maximum gradation.

FIG. 10 illustrates a deterioration in the phosphors. An ordinate axis in FIG. 10 shows a deterioration rate of the phosphors. The deterioration rate of the phosphors is 1 at an initial state (a state that the drive time is zero). As the value of the deterioration rate becomes smaller, the deterioration amount is larger. An abscissa axis in FIG. 10 shows the drive time. The drive time here means time obtained by accumulating corresponding values in the case of assuming that a signal with maximum gradation is applied, and the drive time is approximately proportional to the total electric charge injection amount. Therefore, the total electric charge injection amount is obtained from the drive time data of the second storing unit 12, so that the deterioration rate of the phosphors can be calculated according to the Formula 4. A unit of the total electric charge injection amount is [C/cm²].

A fluctuation (broken line) of the emission current in FIG. 9 is fitted by algorithmic approximation formula of Formula 5 (solid line).

Ii=ci×Log(Ti)+di (Formula 5)

Ii denotes a prediction device current, and Ti denotes accumulated drive time. The coefficients ci and di are parameters which do not depend on time. In the second embodiment, the coefficients ci and di are stored as the luminance variation characteristic data in the first storing unit 11. When a unit of the time Ti in the Formula 5 is hour (time) and a unit of the prediction device current Ii is μA, the coefficient ci roughly obtains a value of −15 to 15, and the coefficient di roughly obtains a value of 3 to 10.

Similarly to the first embodiment, also in the second embodiment, the coefficients ci and di are obtained by fitting the Formula 5 to the fluctuation in the device current up to 100 hours at the initial driving stage. As shown in FIG. 9, a fitting curve (solid line) obtained from the fluctuation in the device current for 100 hours of the initial driving is fitted to the fluctuation in the device currents after 100 hours very well.

The fluctuation in the device current in FIG. 9 is different from the fluctuation in the luminance of FIG. 2 in that the fluctuation in the device current is not related with the deterioration rate of the phosphors. For this reason, in FIG. 9, even if the drive time exceeds 10000 hours, misfit of the fitting curve seen in FIG. 2 does not occur.

The drive time data is stored in the second storing unit 12 as shown in FIG. 4A or 4B.

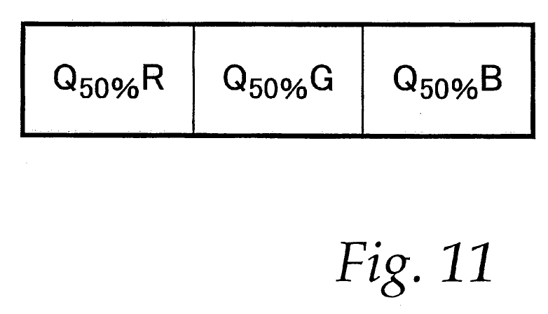

FIG. 11 schematically illustrates a data structure of the third storing unit 15. The image display apparatus of the second embodiment has phosphors of three colors R, G and B, and the deterioration characteristics vary depending on color. Therefore, the deterioration characteristics Q_{50%}R, Q_{50%}G, and G_{50%}B of R, G and B are stored in the third storing unit 15. For example, the deterioration characteristic of the phosphor Q_{50%} roughly takes a value of 102 to 105 [C/cm²].

A correction example is described. The correction value calculation unit 13 reads the coefficients ci and di from the first storing unit 11, and reads the drive time Ti from the second storing unit 12. The prediction device currents Ii of the display devices at the drive time Ti are calculated by the Formula 5. The correction value calculation unit 13 reads the deterioration characteristics Q_{50%} of the phosphors with respective colors from the third storing unit 15, and converts the drive time Ti into the total electric charge injection amount Q, so as to calculate the luminance efficiency A of the phosphors according to the Formula 4. The value of the initial luminance efficiency A0 is known.

Prediction luminance L is obtained based on the prediction device currents I and the deterioration rate of the phosphors by Formula 6. In the Formula 6, A denotes the luminance efficiency of the phosphors, and γ is a gamma coefficient. The value of the gamma coefficient γ is known.

L=A×I^{γ} (Formula 6)

After the prediction luminance of all the display devices is calculated according to the Formula 6, correction values of the devices are calculated by the method similar to that in the first embodiment. The input image data is corrected by using the calculated correction values so that the luminance unevenness is reduced.

In the above description, the logarithmic approximation formula like the Formula 5 is used, but similarly to the first embodiment, the coefficients ci and di may be obtained by using an approximation formula such as a Formula 7 where an aging period is taken into consideration or a linear formula such as a Formula 8. T0 in the Formula 7 is offset time corresponding to the aging period.

Ii=ci×Log(Ti−T0)+di (Formula 7)

Ii=ci+di×Ti (Formula 8)

(Measuring Period of Variation with Time)

In the second embodiment, luminance variation characteristic data is calculated by using the Formula 5, 7 or 8 based on the measured results of the device currents for 100 hours at the initial driving stage. That is to say, long-term luminance variation characteristics specific to the devices can be estimated only by measuring the initial variation in the device currents with time, and the parameters to be stored in the first storing unit 11 can be determined. The measuring period is not limited to 100 hours, and it can be suitably determined according to the characteristics of the devices to be used.

As shown in FIG. 10, the phosphors in the second embodiment are hardly deteriorated until 100 hours at the initial driving stage. For this reason, the parameters to be stored in the first storing unit 11 may be calculated based on the values obtained by measuring the luminance like the first embodiment. This is because the fluctuation in the luminance at the initial driving stage can be regarded as not including a fluctuation component due to the deterioration of the phosphors.

### (Modulating Method)

A modulating method is similar to that in the first embodiment.

### (Block Diagram)

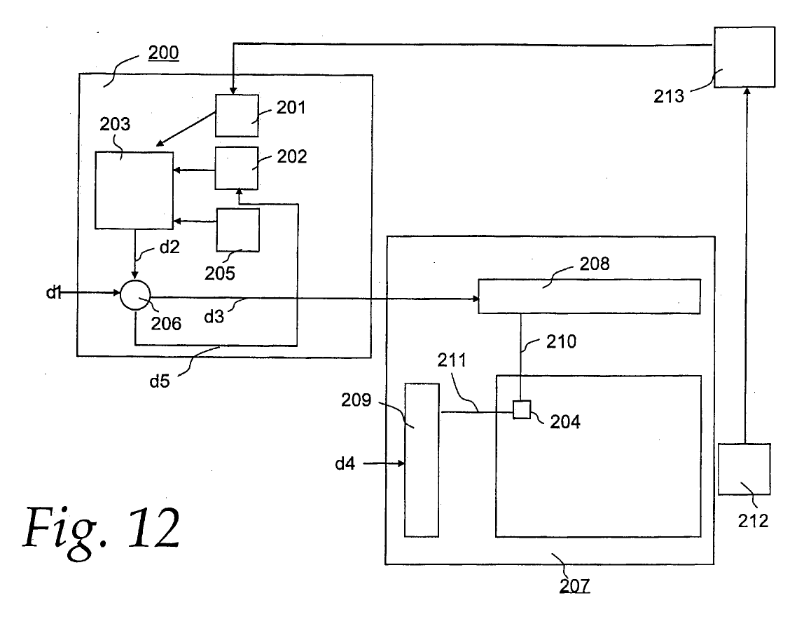

FIG. 12 is a block diagram illustrating details of the image display apparatus in FIG. 8. The image display apparatus has a display panel 207 and a correction circuit 200. The display panel 207 has a plurality of display devices 204, a modulating circuit 208, a scanning circuit 209, column-wide wirings 210, and row-direction wirings 211. The correction circuit 200 has a first storing unit 201, a second storing unit 202, a third storing unit 205, a correction value calculation unit 203, and a multiplier 206. A reference numeral 212 is the unevenness measuring unit, and a reference numeral 213 denotes the operating unit which calculates the luminance variation characteristic data to be stored in the first storing unit 201. The unevenness measuring unit 212 and the operating unit 213 may be components of the image display apparatus or may be component independent from the image display apparatus.

The image display apparatus in FIG. 12 different from the image display apparatus in FIG. 7 in that the luminance variation characteristic data of the first storing unit 201 is data representing the variation in the device currents with time, and that the third storing unit 205 is provided. The correction value calculation unit 203 calculates the correction values for each of the devices based on the luminance variation characteristic data in the first storing unit 201, the drive time data in the second storing unit 202, and the phosphor deterioration characteristic data in the third storing unit 205. The other constitution parts are similar to those of the image display apparatus in FIG. 7.

According to the above constitution, both the variation characteristic in the electron-emitting devices with time and the variation characteristic in the phosphors with time are taken into consideration, so that the correction of the luminance unevenness with high accuracy can be realized.

### Third Embodiment

A third embodiment of the present invention is described.

The basic constitution in the third embodiment is similar to that in the second embodiment. In the second embodiment, the values representing the variation in the device currents specific to the display devices with time are stored in the first storing unit, but in the third embodiment, values representing the variation in the luminance specific to the display devices with time obtained from the measured values of the luminance are stored in the first storing unit.

Also in the third embodiment, the values representing the deterioration of the phosphors are stored in the third storing unit similarly to the second embodiment.

The luminance of the display devices depends on not only the levels of the device currents but also the luminance efficiency of the phosphors. Considering this, when the values obtained from the measured values of the luminance are used as the parameters (luminance variation characteristic data) to be stored in the first storing unit, one might think that the fluctuation in the luminance due to the deterioration of the phosphors is corrected excessively (doubly). However, as shown in FIG. 10, since the phosphors are hardly deteriorated at the initial driving stage, the fluctuation in the luminance measured at the initial driving stage (for example, 100 hours) hardly includes a fluctuation component due to the deterioration of the phosphors. Therefore, the problem of the excessive correction does not arise. On the contrary, when the deterioration characteristics of the phosphors is taken into consideration, the reduction in the correcting accuracy due to the shift between the luminance and the fitting curve which is indicated in the first embodiment (see FIG. 2) can be dissolved.

The third embodiment can be applied suitably and particularly to a case where the measurement of the luminance is easier than the measurement of the device currents, or a case where measurement accuracy of the luminance is better than that of the device currents, or a case where the measurement time of the luminance is shorter than that of the device currents.

### EXAMPLES

### Basic Constitution of Image Display Apparatus

A basic constitution of the image display apparatus of Examples is described below.

An electron source in the Examples has a plurality of electron-emitting devices, and a plurality of row-direction wirings and a plurality of column-direction wirings, which connect the electron-emitting devices into a matrix pattern, on a substrate.

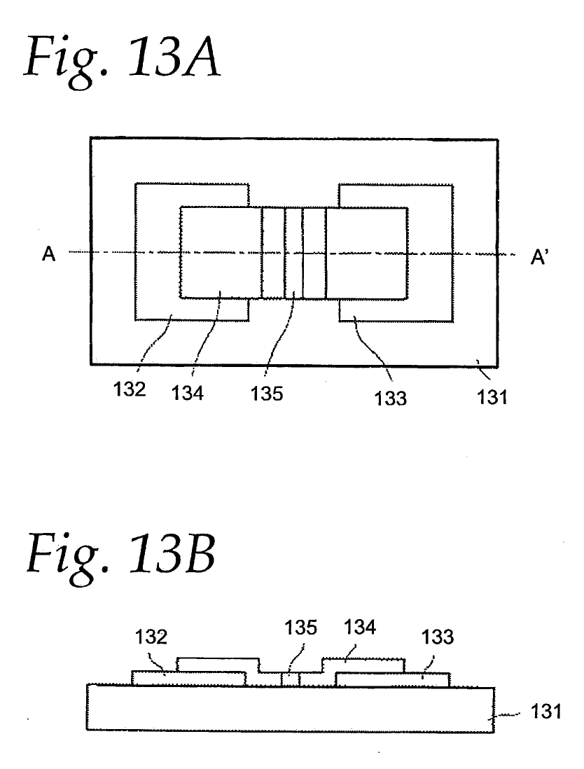

A surface-conduction electron-emitting device (“SCE device”) is an example of the electron-emitting devices composing the electron source, and its constitutional example is schematically shown in FIGS. 13A and 13B. FIG. 13B is a cross-sectional view taken along line A-A′ of FIG. 13A. 131 denotes a substrate, 132 and 133 denote device electrodes, 134 denotes a conductive film, and 135 denotes an electron emission portion.

A method for manufacturing an SCE device shown in FIG. 13A is as described below. A pair of device electrodes 132 and 133 is formed on an electrically insulating substrate 131. A conductive film 134 is formed so as to be connected to the device electrodes 132 and 133. Therefore, the conductive film 134 is subject to an energizing process which is called as forming. As a result, the conductive film 134 is locally broken, deformed or transformed, so that there is formed an electrically high-resistant portion including a crack (electron emission portion 135). When a voltage is applied between the device electrodes 132 and 133 and an electric current is applied to the conductive film 134, electrons are emitted from the electron emission portion 135.

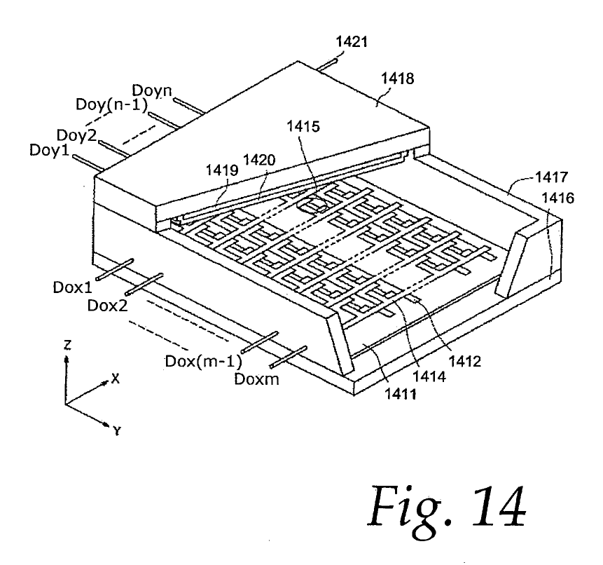

One example of the image display apparatus using the electron source where the electron-emitting devices shown in FIG. 13A are connected by matrix wiring is described with reference to FIG. 14. FIG. 14 is a pattern diagram illustrating a state that a display panel of the image display apparatus is partially cut away.

In FIG. 14, 1415 denotes the electron-emitting device shown in FIG. 13, 1416 denotes a rear plate, and 1418 denotes a face plate made of a glass substrate. The electron-emitting devices 1415 are connected to the column-direction wirings 1412 and the row-direction wirings 1414. A fluorescent film 1419, a metal back 1420 and the like are formed on an inner surface of the face plate 1418. 1417 denotes a supporting frame, and 1421 denotes a high-voltage power source. The rear plate 1416, the supporting frame 1417 and the face plate 1418 are sealed so that an envelope is constituted. A vacuum of about 10⁻⁵ Pa, for example, is maintained in the envelope. When the electron source substrate 1411 has sufficient strength, the electron source substrate 1411 may be bonded directly to the supporting frame 1417 without using the rear plate 1416.

In order to improve the strength against atmospheric pressure, a supporter, not shown, which is called a spacer is preferably provided between the face plate 1418 and the electron source substrate 1411.

Further, in order to maintain the degree of vacuum in the sealed envelope, a getter process is preferably executed before and the after the sealing.

### Example 1

An Example 1 of the image display apparatus is described with reference to FIG. 7.

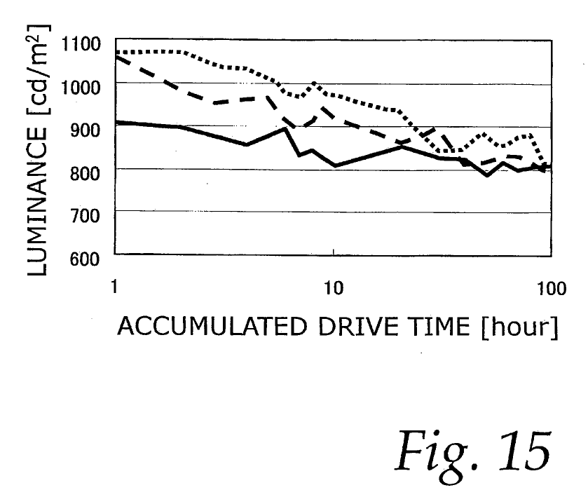

At the manufacturing process for the image display apparatus, the luminance of the respective display devices is measured. The display devices are driven by driving signals corresponding to the maximum gradation, and a fluctuation in the luminance for 100 hours is recorded. CCD cameras are used for measuring the luminance. Concretely, all the display devices are allowed to emit light by the same image data, and the entire display surface is divided to be measured by a plurality of CCD cameras. One example of the measured luminance is shown in FIG. 15. FIG. 15 illustrates the fluctuation in the luminance of the three display devices for 100 hours. An ordinate axis in FIG. 15 shows the luminance corresponding to the maximum gradation, and an abscissa axis shows the drive time at the maximum gradation.

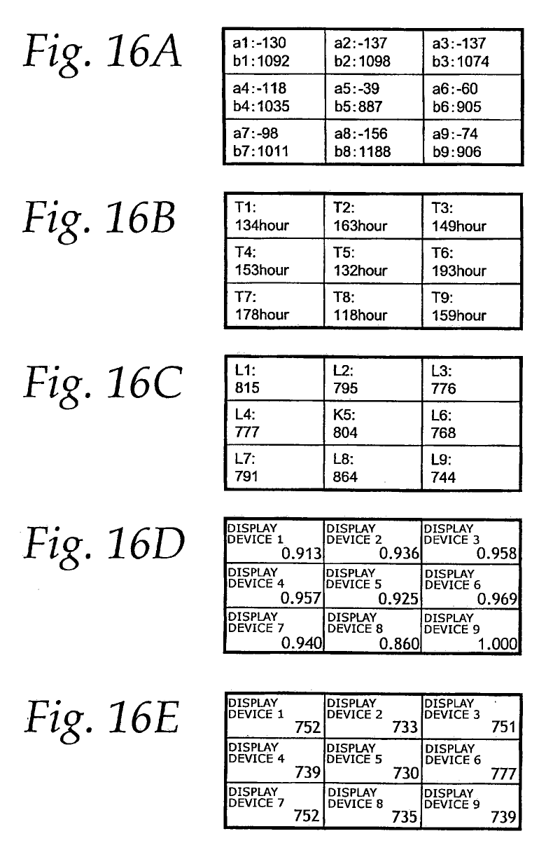

The approximation curve in the Formula 1 was fitted to the luminance measured results of the display devices, so that the coefficients ai and bi of each display device were obtained. The coefficients ai and bi were stored in the first storing unit 101. FIG. 16A illustrates examples of the coefficients ai and bi of the display devices stored in the first storing unit 101. In the Example 1, the range of the coefficient ai became −40 to −180, and the range of the coefficient bi became 800 to 1400.

The second storing unit 102 stores the drive time data of the display devices therein (see FIG. 4A). The drive time data is not actual accumulated drive time but corresponding values at the time of assuming that the display devices are driven at maximum gradation.

A luminance unevenness evaluating method for checking an effect due to the carrying-out of the present invention is described below.

A test image signal is used for evaluating luminance unevenness. Pulse width modulation was used as the modulating method. The gradation at each time was set to random values according to normal distribution having an average of 50% of the maximum gradation and a standard deviation of 15%. A driving voltage was set to 16V, a driving voltage pulse width at the time of maximum gradation was set to 5 μsec, and the devices were driven at 60 Hz.

The values in the first storing unit 101 and the second storing unit 102 were used, so that the variation amount in the luminance with time (prediction luminance Li) was calculated by the correction value calculation unit 103. Correction target values were determined based on the prediction luminance of all the devices, and the correction values of the devices were obtained from the correction target values. And, the test image signals input into the display devices were corrected.

A correction example for 100 hours after the starting of the luminance unevenness evaluation is concretely described. The corrected results of the nine devices are described for simple description. FIG. 16B illustrates the drive time data Ti of the devices stored in the second storing unit 102 after 100 hours from the starting of the luminance unevenness evaluation. FIG. 16C illustrates the prediction luminance Li which is obtained by using the coefficients ai and bi in FIG. 16A and the drive time data Ti in FIG. 16B according to the Formula 1. The correction target value was determined as minimum luminance in the nine devices (in the Example 1, L9=744), and the correction values of the devices were calculated as shown in FIG. 16D. The luminance measured after the correction with this correction value was as shown in FIG. 16E.

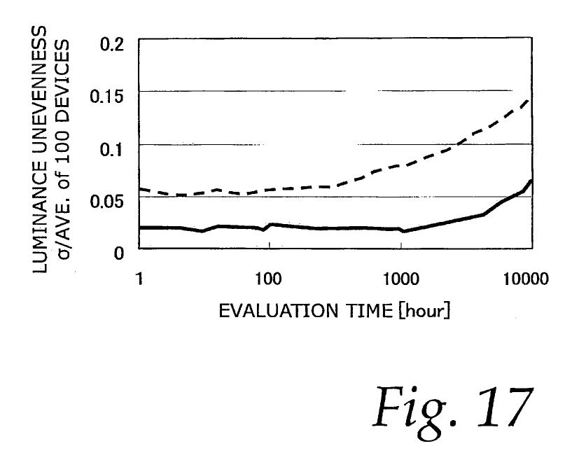

FIG. 17 illustrates the effect of the correction in the Example 1. An ordinate axis in FIG. 17 shows the luminance unevenness (σ/average value of the luminance of the 100 devices), and an abscissa axis shows elapsed time (hour) after the starting of the luminance unevenness evaluation using logarithmic scale. A graph of a solid line shows the result of the correction in the Example 1, and a graph of a broken line shows a result of a comparative example, mentioned later. In the correction in the Example 1, the correction values of the devices are calculated based on the specific luminance variation characteristics obtained from the luminance measured values, and the accumulated drive time of the respective devices which is recorded. The correction in the Example 1 improves the deterioration in the luminance unevenness with time as shown in FIG. 17.

### Comparative Example

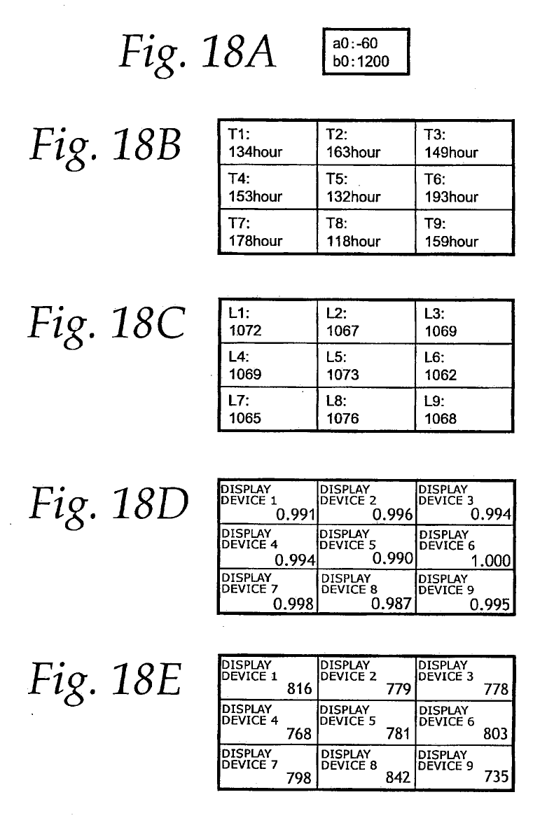

In the Example 1, the correction was carried out by using the luminance variation characteristics specific to the display devices (coefficients ai and bi) On the contrary, in the comparative example, the correction is carried out by using coefficients a0 and b0 which are uniform in all the display devices. The coefficients a0 and b0 in the comparative example were obtained by fitting the approximation curve in the Formula 1 to the measured result of the luminance of a certain representative device. FIG. 18A illustrates examples of the coefficients a0 and b0 stored in the first storing unit in the comparative example. a0 became −60, and b0 became 1200.

As shown in FIG. 18B, the drive time data of the display devices were stored in the second storing unit.

Test image signals were used for evaluating the luminance unevenness similarly to the Example 1.

The prediction luminance was calculated by using the values shown in FIGS. 18A and 18B according to the method similar to that in the Example 1 (see FIG. 18C). The minimum prediction luminance (L6=1062) was selected as the correction target value, and the correction values of the devices were calculated (see FIG. 18D). The luminance measured after the correction with this correction values were as shown in FIG. 18E.

A broken line of FIG. 17 shows the corrected result in the comparative example. It is found that the effect for reducing the luminance unevenness is greatly different between the use of the luminance variation characteristics specific to each device (Example 1) and the use of the uniform luminance variation characteristics (comparative example).

### Example 2

In the Example 2, in order to reduce a storage region of the second storing unit, a central value of the accumulated drive time (see FIG. 4B) was used. The other portions were the same as those in the Example 1. 50% of the actual drive time is used as the central value of the accumulated drive time.

Test image signals similarly to the Example 1 were used for evaluating the luminance unevenness.

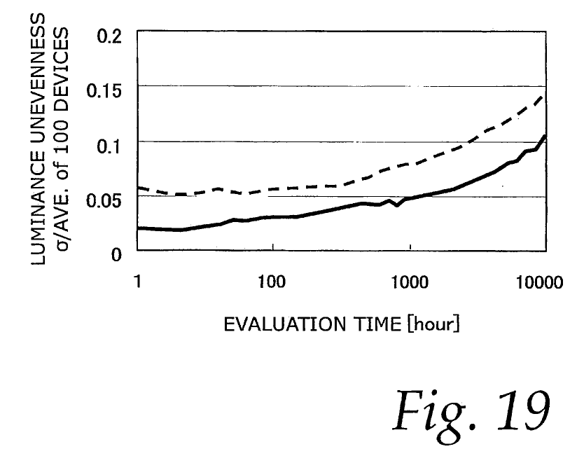

FIG. 19 illustrates an effect due to the correction in the Example 2 (the variation in the luminance unevenness with time). A solid line shows the corrected result of the Example 2, and a broken line shows the corrected result in a comparative example. Since the luminance variation characteristics specific to the devices are used also for the correction in the Example 2, it is found that the deterioration in the luminance unevenness with time is improved more sufficiently than the comparative example.

### Example 3

An Example 3 of the image display apparatus is described with reference to FIG. 12. In the correction in the Example 3, the deterioration characteristics of the phosphors are also taken into consideration.

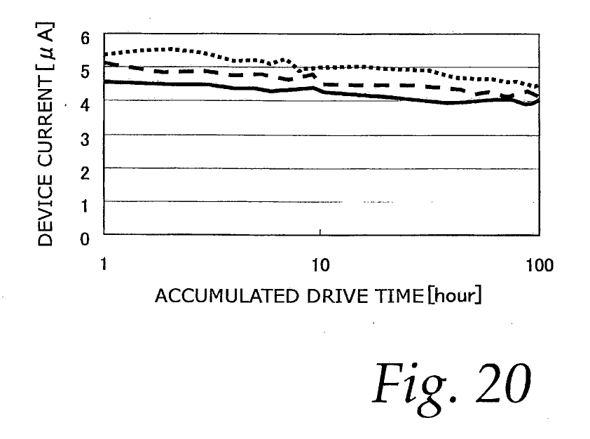

A fluctuation in the luminance for 100 hours at the initial driving state was measured by the method similar to that in the Example 1. The measured luminance was converted into the device currents by the Formula 6. At this time, 0.7 was used as γ in the Formula 6, an initial values of the luminance efficiency of the phosphors were used as A. FIG. 20 illustrates an example of the fluctuation in the device currents of three display devices for 100 hours.

The approximation curve in the Formula 5 was fitted to the fluctuation in the device currents of the display devices, so that the coefficients ci and di of the display devices were obtained. The coefficients ci and di were stored in the first storing unit 201. The range of the coefficient ci became −2 to −4, and the range of the coefficient di became 4 to 6. The drive time data of the display devices (corresponding values assuming that devices were driven at maximum gradation) is stored in the second storing unit 202 (see FIG. 4A). The deterioration characteristics Q_{50%}R, Q_{50%}G and G_{50%}B of the phosphors are stored in the third storing unit 205 (see FIG. 11). Concretely, Q₅₀% R=2×10⁴[C/cm²], Q_{50%}G=1×10⁴[C/cm²] and Q_{50%}B=2.5×10⁴[C/cm²] were used.

Test image signals similarly to the Example 1 were used for evaluating the luminance unevenness.

The correction value calculation unit 203 obtained variation amount in the device currents with time (prediction device currents Ii) based on the value in the first storing unit 201 and the value in the second storing unit 202. The deterioration rates of the phosphors were obtained by using the values in the second storing unit 202 and the values in the third storing unit 205. The variation amount in the luminance of the display devices with time were calculated based on the variation amount in the device currents with time and the deterioration rates of the phosphors. Correction target values were determined based on the variation amount in the luminance of the devices with time, and the correction values of the devices were obtained from the correction target values. And, the test image signals input into the devices, respectively, were corrected using the correction values.

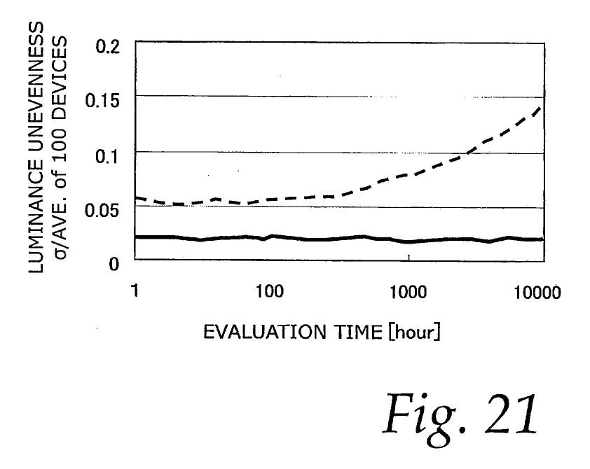

The luminance unevenness was evaluated similarly to the Example 1. FIG. 21 illustrates the effect due to the correction in the Example 3. A solid line shows the corrected result in the Example 3, and a broken line shows a corrected result in the comparative example. In the correction in the Example 3, since also the deterioration characteristics of the phosphors are taken into consideration, the deterioration in the luminance unevenness with time is improved more sufficiently than the correction in the Example 1.

### Example 4

In the Example 4, in order to reduce the storage region in the second storing unit, a central value of the accumulated drive time (see FIG. 4B) was used. The other parts were the same as those in the Example 3. 50% of the actual drive time was used as the central value of the accumulated drive time.

Test image signals similar to that in the Example 1 were used for evaluating the luminance unevenness.

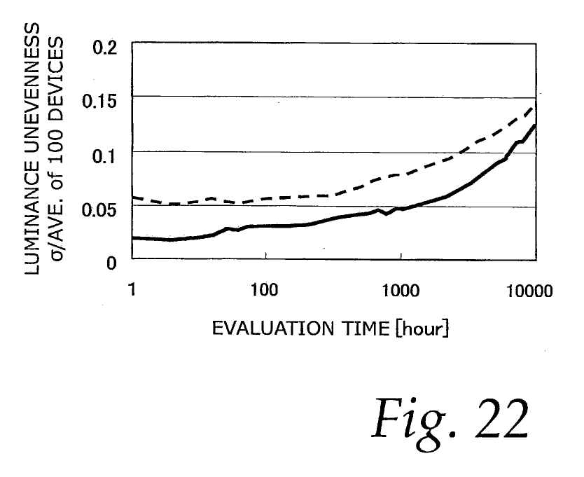

FIG. 22 illustrates an effect due to the correction in the Example 4. A solid line shows a corrected result in the Example 4, and a broken line shows a corrected result in the comparative example. It is found that the deterioration in the luminance unevenness with time in the Example 4 is improved more sufficiently than that in the comparative example.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-168486, filed Jun. 27, 2007 which is hereby incorporated by reference herein in its entirety.

What is claimed is:

1. An image display apparatus, comprising:
a plurality of display devices; and
a correction circuit which corrects image data in order to reduce luminance unevenness among the plurality of display devices,
wherein the correction circuit includes:
a first storing unit which stores first characteristic data of each of the display devices which represent variation characteristics of luminance with respect to drive time;
a second storing unit which stores drive time data which represent values correlated with the drive time of the display devices and are updated when the display devices are driven; and
a calculation unit which calculates correction values corresponding to each of the display devices based on the first characteristic data and the drive time data.

2. An image display apparatus according to claim 1, wherein the first characteristic data are data which are calculated based on measured values obtained by measuring the luminance or physical quantity correlated with the luminance of the display devices at the time of driving the display device for a predetermined measuring period.

3. An image display apparatus according to claim 1, wherein
the display devices have phosphors,
the correction circuit has a third storing unit which stores second characteristic data representing deterioration characteristics of the phosphors with respect to the drive time, and
the calculation unit calculates the correction values corresponding to each of the display devices based on the first characteristic data, the second characteristic data and the drive time data.

4. An image display apparatus according to claim 1, wherein the drive time data represent an accumulated total of the drive time of the display devices.

5. An image display apparatus according to claim 1, wherein the drive time data represent an accumulated total of values obtained by adjusting the drive time of the display devices according to their gradation values.

6. An image display apparatus according to claim 1, wherein the drive time data of the plurality of display devices are updated and stored, respectively with respective to each of the display devices.

7. An image display apparatus according to claim 1, wherein the drive time data is used commonly among two or more display devices when the calculation unit calculates the correction values.

8. An image display apparatus according to claim 1, wherein
the plurality of display devices includes display devices whose variation characteristics of the luminance with respect to the drive time varies, and
the correction values are used for correction to reduce the luminance unevenness caused by a difference in the variation characteristics.

9. An image display apparatus according to claim 1, wherein the display devices have electron-emitting devices.

10. An image display apparatus according to claim 9, wherein the electron-emitting devices are surface-conduction emission devices.

11. A method for manufacturing an image display apparatus having a plurality of display devices, comprising the steps of:
measuring luminance or physical quantities correlated with the luminance of the display devices at the time of driving the display devices for a predetermined measuring period;
calculating first characteristic data of each of the display devices which represent variation characteristics of luminance with respect to drive time based on measured values obtained at the measuring step; and
storing the calculated first characteristic data in a storing unit of the image display apparatus.

12. A method for manufacturing the image display apparatus according to claim 11, wherein the plurality of display devices includes display devices whose variation characteristics of the luminance with respect to the drive time varies.

13. A method for manufacturing the image display apparatus according to claim 11, wherein the display devices have electron-emitting devices.

14. A method for manufacturing the image display apparatus according to claim 13, wherein the electron-emitting devices are surface-conduction emission devices.
